(19) United States
(12) Patent Application Publication
(10) Pub. No.: US 2014/0271378 A1
(43) Pub. Date: Sep. 18, 2014

(54) RESONATING COMPONENTS FOR SONIC GENERATORS

(71) Applicant: PetroSonic Energy Inc., Calgary (CA)

(72) Inventors: Art Agolli, Calgary (CA); Patrick Brunelle, Langdon (CA); Alfred Fischer, Calgary (CA)

(73) Assignee: PetroSonic Energy Inc., Calgary (CA)

(21) Appl. No.: 14/209,105

(22) Filed: Mar. 13, 2014

Related U.S. Application Data
(60) Provisional application No. 61/789,672, filed on Mar. 15, 2013.

(51) Int. Cl. B01J 19/10

(52) U.S. Cl. CPC B01J 19/10
USPC 422/128

(57) ABSTRACT

A sonic reactor and resonating components for sonic reactors are disclosed; where these resonating components may have optimized mass and shape. The mass of the resonating component may be redistributed to increase the energy transmission of towards the resonance chambers and optimize the system for specific application requirements. The proper selection of the material may allow improved elasticity and lower internal damping, which may increase the amplitude at a given power and the tuning of the natural frequency; these factors may also translate on higher energy transmission towards the resonance chambers.

### CROSS REFERENCE TO RELATED APPLICATIONS

This application claims priority to U.S. Provisional Patent Application Ser. No. 61/789,672, filed Mar. 15, 2013, entitled “Resonating Components for Sonic Generators,” which is hereby incorporated by reference in its entirety.

### BACKGROUND

1. Technical Field

The present disclosure relates generally to sonic generators, and more particularly to resonating component design considerations.

2. Background Information

Solvent deasphalting is a known solution for upgrading heavy crude oils into synthetic crude oils (SCOs), where the SCOs show an improved API gravity and a removal of one or more generally undesired elements in the oil, including asphalstenes, nickel, vanadium, and sulfur, amongst others. Some methods for performing this type of deasphalting use vibrational energy to aid in the process, typically using one or more vibrating bars.

However, the use of vibrational energy or this purpose is somewhat recent, and the operational and design parameters of one or more aspects of these devices remains unknown in the art.

### SUMMARY

A sonic reactor and resonating components for sonic reactors are disclosed; where these resonating components may have optimized mass and shape. The sonic generator includes at least one resonating component, having a plurality of nodes and antinodes; a substantially elastic support system located between a housing and the resonating component; electromagnetic drive means in close proximity to the resonating component and capable of exerting an electromagnetic force on the resonating component and at least one resonance chamber mechanically coupled to the resonating component and capable of containing a volume of fluidized media.

The electromagnetic drive means may excite the resonating component to its natural frequency to make it resonate in such a way that the energy that propagates radially may be transmitted to the resonance chambers.

The disclosed resonating components may have optimal thickness, length, Young's modulus, and density that may allow the rapid transmission of large amounts of energy to the resonance chambers.

In one embodiment, a sonic reactor comprises a resonating component having a variable diameter along the length of the resonating component from a first end to a second end, wherein a first portion of the resonating component has a first diameter, a second portion of the resonating component has a second diameter, and the first diameter is different than the second diameter; a resonating chamber configured to contain a fluid; a substantially elastic support system located between a housing and the resonating component; and an electromagnetic drive means proximate to the resonating component for exerting an electromagnetic force on the resonating component and the resonating chamber. In one alternative, the first portion of the resonating component is at the first end and the second end, the second portion of the resonating component is between the first end and the second end, and the first portion has a larger diameter than the second portion. In another alternative, the resonating component has a larger diameter at the first end and the second end than a diameter in a center of the resonating component.

In another alternative, the first portion of the resonating component is at the first end and the second end, the second portion of the resonating component is between the first end and the second end, and the second portion has a larger diameter than the first portion. In another alternative, wherein the resonating component has a larger diameter at a center of the resonating component than a diameter at the first end and the second end of the resonating component. In another alternative, the resonating component comprises a first diameter at the first portion at the first end, a second diameter at the second portion proximate to the first portion, a third diameter at a third portion proximate to the second portion, a fourth diameter at a fourth portion proximate to the third portion, and a fifth diameter at the second end, wherein the first diameter is the same as the fifth diameter, the second diameter is the same as the fourth diameter, and the second diameter and fourth diameter are larger than the first diameter and fifth diameter. In another alternative, the third diameter is the same as the first diameter and fifth diameter. In another alternative, the third diameter is smaller than the diameter of the second diameter and the fourth diameter.

In another embodiment, a sonic reactor comprises a resonating component having three substantially flat sides extending along the length of the resonating component; a resonating chamber configured to contain a fluid; a substantially elastic support system located between a housing and the resonating component; and an electromagnetic drive means proximate to the resonating component for exerting an electromagnetic force on the resonating component and the resonating chamber. The resonating component may have a triangular cross-section.

In yet another embodiment, a sonic reactor comprises resonating component having four substantially flat sides extending along the length of the resonating component; a resonating chamber configured to contain a fluid; a substantially elastic support system located between a housing and the resonating component; and an electromagnetic drive means proximate to the resonating component for exerting an electromagnetic force on the resonating component and the resonating chamber. The resonating component may have a rectangular cross-section. The resonating component may have a square cross-section.

In another embodiment, a sonic reactor comprises a resonating component having a plurality of substantially flat sides extending along the length of the resonating component; a resonating chamber configured to contain a fluid; a substantially elastic support system located between a housing and the resonating component; and an electromagnetic drive means proximate to the resonating component for exerting an electromagnetic force on the resonating component and the resonating chamber. The resonating component may have an octogonal cross-section. The resonating component may have eight flat sides extending along the length of the resonating component.

Numerous other aspects, features and advantages of the present disclosure may be made apparent from the following detailed description, taken together with the drawing figures.

### BRIEF DESCRIPTION OF THE DRAWINGS

Embodiments of the present disclosure are described by way of example with reference to the accompanying figures, which are schematic and are not intended to be drawn to scale. Unless indicated as representing prior art, the figures represent aspects of the present disclosure.

FIG. 1A depicts an isometric view of a sonicator used in upgrading heavy oil feedstocks, according to an embodiment of present disclosure.

FIG. 1B depicts a front view of a sonicator used in upgrading heavy oil feedstock, according to an embodiment of present disclosure.

FIG. 1C depicts a sectional view of a sonicator, according to an embodiment of present disclosure.

FIG. 1D depicts a second sectional view of a sonicator, according to an embodiment of present disclosure.

FIG. 2A shows a first characteristic mode shape of a resonating component, according to an embodiment of present disclosure.

FIG. 2B shows a second characteristic mode shape of a resonating component, according to an embodiment of present disclosure.

FIG. 3 shows a resonating component, according to an embodiment of present disclosure.

FIG. 4 shows a resonating component, according to an embodiment of present disclosure.

FIG. 5 shows a resonating component, according to an embodiment of present disclosure.

FIG. 6A shows a resonating component, according to an embodiment of present disclosure.

FIG. 6B shows a resonating component, according to an embodiment of present disclosure.

FIG. 6C shows a resonating component, according to an embodiment of present disclosure.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### Definitions

As used here, the following terms have the following definitions:

“Heavy Oil Feedstock (HOF)” may refer to any material containing petroleum with an API gravity of less than 20° API, including heavy crude oils, oil sands, and bitumen.

“Upgrade” may refer to altering the chemical and/or physical properties of petroleum containing materials so as to increase the value of one or more of the resulting materials.

“Sonic Reactor” may refer to a device for upgrading HOFs by at least sonication.

“Reaction Chamber” may refer to a cavity in a sonic reactor where HOFs may be upgraded.

“Resonant Component” may refer to an element of a system which vibrates as part of the operation of a sonic reactor.

“Sonication” may refer to any device or system which produces vibrational energy sufficient to impact one or more desired end uses.

### Description of the Drawings

Various example embodiments of the present disclosure are described more fully with reference to the accompanying drawings in which some example embodiments of the present disclosure are shown. Illustrative embodiments of the present disclosure are disclosed herein. However, specific structural and functional details disclosed herein are merely representative for purposes of describing example embodiments of the present disclosure. This disclosure however, may be embodied in many alternate forms and should not be construed as limited to only the embodiments set forth herein.

FIG. 1A shows an isometric view 102, FIG. 1B shows front view 104, FIG. 1C shows right plane section 106, and FIG. 1D shows front plane section 108 view of sonic reactor 100, according to an embodiment of present disclosure. Sonic reactor 100 includes at least one resonating component 110, electromagnetic drive means 112, elastic support system 114, housing structure 116, and reaction chambers 118.

Resonating component 110 may have one or more natural frequencies and may be mounted on housing structure 116 using elastic support system 114. Elastic support system 114 may be placed between resonating component 110 and housing structure 116 and may be in physical contact with resonating component 110 at the node points; where there is substantially no vibration amplitude when resonating component 110 is vibrating at its natural frequency. This disposition of elastic support system 114 may minimize the loss of energy caused by the system. The electromagnetic drive means 112 may be positioned at the ends of resonating component 110. In one embodiment, electromagnetic drive means 112 may include series of electromagnets arranged around the ends of the resonating component 110 and may be connected to a controller and a power source. Electromagnetic drive means 112 may be capable of exciting resonating component 110 to at least one natural frequency and maintain the system in resonance for a desired time.

The vibration of resonating component 110 at its natural frequency may result in high amounts of energy being transferred to the reaction chambers 118, which may be mechanically coupled to resonating component 110. This energy may be used to accelerate chemical reactions. One example of such reactions is the deasphalting of HOF. According to an embodiment, HOF in reaction chambers 118 may have previously been chemically altered to allow the upgrading of HOF in reaction chamber 118, methods for preparing it for such including the addition of one or more solvents.

The period of time needed to upgrade HOF in reaction chambers 118 may vary in dependence with a number of factors, including the amplitude and frequency of the vibration of resonating component 110. The amplitude and frequency of the vibration of resonating component 110 may in turn depend the interrelation of several characteristics of the system including the shape and mass of the resonating component 110, the mass and location of the reaction chambers 118, the design of the elastic support system 114, the properties and location of electromagnetic drive means 112, and the characteristics of the power supply among others.

The amplitude of the vibration depends on the excitation force and the damping characteristics of the system. The actual amplitude of sonic reactor 100 is a result of the equilibrium between the energy supplied to the system by the excitation force and the energy dissipated in the system. The energy dissipated by the system may be referred as damping. The damping in sonic reactor 100 may have two components, the internal damping and the external damping. The internal damping refers to the energy that may dissipate due to the resonating component 110 and may be affected by the material properties and the shape of resonating component 110. The external damping effects may be affected by the mass of reaction chambers 118, the friction between elements and other energy dissipating factors. Typically, the external damping is an order of magnitude higher than the internal damping.

The mass of the resonating component may be redistributed to increase the energy transmission of towards the resonance chambers and optimize the system for specific application requirements. A appropriate selection of the material may allow improved elasticity and lower internal damping, which may increase the amplitude at a given power and the tuning of the natural frequency; these factors may translate on higher energy transmission towards the resonance chambers.

FIG. 2A shows a first characteristic mode shape 200 of a resonating component, according to an embodiment of present disclosure. First characteristic mode shape 200 may depict the motion of resonating component when being excited at its first natural frequency. As shown in FIG. 2A, resonating component may include a number of nodes 202 and antinodes 204. Nodes 202 may be placed at points along the axis of symmetry 206 of the resonating component. Nodes 202 represent the points along resonating component at which there is substantially no motion. Conversely, antinodes 204 may represent the points of maximum displacement within resonant component. First characteristic mode shape 200 may depict a portion of a sinusoidal wave having two nodes 202 and three antinodes 204.

FIG. 2B shows a second characteristic mode shape 208 of a resonating component, according to an embodiment of present disclosure. Second characteristic mode shape 208 may depict the motion of resonating component when being excited at its second natural frequency. As shown in FIG. 2 resonating component may include a number of nodes 202 and antinodes 204. Nodes 202 may be placed at points along the axis of symmetry 206 of the resonating component. Nodes 202 represent the points along resonating component at which there is substantially no motion. Conversely, antinodes 204 may represent the points of maximum displacement within resonant component. Second characteristic mode shape 208 may depict a portion of a sinusoidal wave having two nodes 202 and three antinodes 204. Amplitudes generally decrease when resonating component is exited at higher natural frequencies.

FIG. 3 shows shape variation 300 of a resonating component 110, according to an embodiment of present disclosure. As shown in FIG. 3, the resonant component may be design to have a variable diameter, such that the center of the resonating component 110 may have a smaller diameter than the sides. This may cause a redistribution of the mass of the resonating component 110 and the displacement of nodes 202. In the case of first natural shape, nodes 202 may move towards the edges of the resonating component 110. The thinner center and heavier sides may help to increase the amplitude of the motion at least of the center antinode 204. The displacement of the nodes 202 towards the edges may reduce the amplitude at a given power, and may increase the natural frequency of the resonating component 110 if the total mass of the resonating component 110 is kept constant.

FIG. 4 shows shape variation 400 of a resonating component 110, according to an embodiment of present disclosure. As shown in FIG. 4, resonant component may be designed to have a variable diameter, such that the center of the resonating component 110 may have a larger diameter than the sides. This may cause a redistribution of the mass of the resonating component 110 and the displacement of nodes 202. In the case of first natural shape, nodes 202 may move towards the center of the resonating component 110. The thicker center and thinner sides may cause a decrease in the amplitude of the motion at least of the center antinode 204. The displacement of the nodes 202 towards the center may increase the amplitude at a given power, and may increase the natural frequency of the resonating component 110 if the total mass of the resonating component 110 is kept constant.

FIG. 5 shows shape variation 500 of a resonating component 110, according to an embodiment of present disclosure. As shown in FIG. 5, resonant component may be designed to have a variable diameter, such that the resonating component 110 may have two thicker sections, equally spaced from the center and located around nodes 202. This redistribution of mass may increase the flexibility of resonant component towards the center and may help to increase the amplitude in all three antinodes 204 while keeping the natural frequency similar to the one of a cylindrical resonant component of the same mass and length.

FIG. 6 shows resonant component profile variations 600, according to an embodiment of present disclosure. FIG. 6A shows a triangular bar 602, FIG. 6B shows a squared bar 604, and FIG. 6C shows an octagonal bar 606.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A sonic reactor comprising:
a resonating component having a variable diameter along the length of the resonating component from a first end to a second end, wherein a first portion of the resonating component has a first diameter, a second portion of the resonating component has a second diameter, and the first diameter is different than the second diameter;
a resonating chamber configured to contain a fluid;
a substantially elastic support system located between a housing and the resonating component; and
an electromagnetic drive means proximate to the resonating component for exerting an electromagnetic force on the resonating component and the resonating chamber.

2. The sonic reactor according to claim 1, wherein the first portion of the resonating component is at the first end and the second end, the second portion of the resonating component is between the first end and the second end, and the first portion has a larger diameter than the second portion.

3. The sonic reactor according to claim 1, wherein the resonating component has a larger diameter at the first end and the second end than a diameter in a center of the resonating component.

4. The sonic reactor according to claim 1, wherein the first portion of the resonating component is at the first end and the second end, the second portion of the resonating component is between the first end and the second end, and the second portion has a larger diameter than the first portion.

5. The sonic reactor according to claim 1, wherein the resonating component has a larger diameter at a center of the resonating component than a diameter at the first end and the second end of the resonating component.

6. The sonic reactor according to claim 1, wherein the resonating component comprises:
a first diameter at the first portion at the first end, a second diameter at the second portion proximate to the first portion, a third diameter at a third portion proximate to the second portion, a fourth diameter at a fourth portion proximate to the third portion, and a fifth diameter at the second end,
wherein the first diameter is the same as the fifth diameter, the second diameter is the same as the fourth diameter, and the second diameter and fourth diameter are larger than the first diameter and fifth diameter.

7. The sonic reactor according to claim 6, wherein the third diameter is the same as the first diameter and fifth diameter.

8. The sonic reactor according to claim 6, wherein the third diameter is smaller than the diameter of the second diameter and the fourth diameter.

9. A sonic reactor comprising:
a resonating component having three substantially flat sides extending along the length of the resonating component;
a resonating chamber configured to contain a fluid;
a substantially elastic support system located between a housing and the resonating component; and
an electromagnetic drive means proximate to the resonating component for exerting an electromagnetic force on the resonating component and the resonating chamber.

10. The sonic reactor according to claim 9, wherein the resonating component has a triangular cross-section.

11. A sonic reactor comprising:
a resonating component having four substantially flat sides extending along the length of the resonating component;
a resonating chamber configured to contain a fluid;
a substantially elastic support system located between a housing and the resonating component; and
an electromagnetic drive means proximate to the resonating component for exerting an electromagnetic force on the resonating component and the resonating chamber.

12. The sonic reactor according to claim 11, wherein the resonating component has a rectangular cross-section.

13. The sonic reactor according to claim 12, wherein the resonating component has a square cross-section.

14. A sonic reactor comprising:
a resonating component having a plurality of substantially flat sides extending along the length of the resonating component;
a resonating chamber configured to contain a fluid;
a substantially elastic support system located between a housing and the resonating component; and
an electromagnetic drive means proximate to the resonating component for exerting an electromagnetic force on the resonating component and the resonating chamber.

15. The sonic reactor according to claim 14, wherein the resonating component has an octogonal cross-section.

16. The sonic reactor according to claim 14, wherein the resonating component has eight flat sides extending along the length of the resonating component.
